(19) United States
(12) Patent Application Publication
(10) Pub. No.: US 2019/0324772 A1
(43) Pub. Date: Oct. 24, 2019

(54) METHOD AND DEVICE FOR PROCESSING SMART CONTRACTS

(71) Applicant: ZhongAn Information Technology Service Co., Ltd., Shenzhen (CN)

(72) Inventors: Beishuang FAN, Shenzhen (CN); Jun ZHU, Shenzhen (CN); Zheng QU, Shenzhen (CN); Junjun DU, Shenzhen (CN)

(21) Appl. No.: 16/460,202

(22) Filed: Jul. 2, 2019

Related U.S. Application Data
(63) Continuation of application No. PCT/CN2018/095784, filed on Jul. 16, 2018.

(30) Foreign Application Priority Data
Jul. 31, 2017 (CN) 201710638423.X

(51) Int. Cl. G06F 9/445; H04L 9/06

(52) U.S. Cl. CPC G06F 9/44521; H04L 9/0637; G06F 9/44589

(57) ABSTRACT

An embodiment of the present application discloses a method and a device for processing smart contracts. The processing method includes: executing the smart contract to be invoked based on a class file corresponding to the smart contract. And the class file is pre-compiled based on program logic of the smart contract to be invoked. By implementing the technical scheme of embodiments of the present application, the smart contract can be directly developed based on a Java language, and no additional compiler or interpreter are required. In addition, all functions of the Java language are basically retained, and the technical scheme of the present application is easy to be accessed and used.

### CROSS-REFERENCE TO RELATED APPLICATIONS

This application is a Continuation Application of PCT application No. PCT/CN2018/095784, filed on Jul. 16, 2018 which claims priority to CN Patent Application No. 201710638423.X, filed on Jul. 31, 2017. All of the aforementioned applications are hereby incorporated by reference in their entireties.

### TECHNICAL FIELD

Embodiments of the present application relate to processing of computer data, in particular to a method and device for processing smart contracts.

### BACKGROUND

A system or module for implementing the smart contract is commonly referred as a smart contract execution engine. An existing smart contract execution engine is mainly implemented by creating a scripting language and its interpreter, which has the following disadvantages: (1) high learning cost, which means developers have to learn the corresponding scripting language in order to use such kinds of blockchains; (2) lack of universality, which means a scripting language can only be used on a specific blockchain platform generally; (3) function limitation, which means this kind of scripting language can only support simple operations and is difficult to satisfy the needs of commercial and engineering level.

Therefore, a method for processing device smart contracts and a device thereof are urgently needed to overcome the above defects.

### SUMMARY

In order to solve the above problems, embodiments of the application provide a method for processing smart contracts and a device thereof.

According to an aspect of the present application, an embodiment of the present application provides a method for processing smart contracts, including: determining a class file corresponding to a smart contract to be invoked based on an invoking request of the smart contract; and executing the smart contract based on the class file; wherein the class file is pre-compiled based on a program logic of the smart contract.

In an embodiment of the present application, the class file includes an instruction and a counter corresponding to the instruction; wherein the executing the smart contract based on the class file includes: counting an execution frequency of the instruction by using the counter, and stop executing the instruction when the execution frequency is more than a preset frequency.

In an embodiment of the present application, the class file includes a plurality of instructions, and corresponding weight is set for each of the instructions; wherein the preset frequency of the instruction is fewer when the weight of the instruction is greater.

In an embodiment of the present application, the determining a class file corresponding to a smart contract to be invoked based on an invoking request of the smart contract includes: searching the class file corresponding to the smart contract in a class file library based on the invoking request.

In an embodiment of the present application, the searching the class file corresponding to the smart contract in a class file library based on the invoking request includes: obtaining identification information, used for indicating the smart contract, in the invoking request; and searching the class file corresponding to the smart contract in the class file library according to the identification information obtained.

In an embodiment of the present application, the determining a class file corresponding to a smart contract to be invoked based on an invoking request of the smart contract includes: generating the class file which satisfies the invoking request according to the identification information, used for indicating the smart contract, in the invoking request.

In an embodiment of the present application, the executing the smart contract based on the class file includes: instantiating the class file and determining functions and parameters in the invoking request; and executing the smart contract based on the class file instantiated, the functions and the parameters.

In an embodiment of the present application, before the determining a class file corresponding to a smart contract to be invoked based on an invoking request of the smart contract, the method further includes: determining the invoking request is legal.

In an embodiment of the present application, the determining the invoking request is legal includes: implementing a consensus process on a format of the invoking request, and determining the invoking request is legal when all nodes reach a consensus that the format of the invoking request is legal.

In an embodiment of the present application, the class file is pre-deployed, and a deployment process of the class file includes: loading the class file to be deployed through a class file loader; and deploying the class file to form a class file library when it is determined that the class file does not comprise a non deterministic class and/or a non deterministic function.

In an embodiment of the present application, the deployment process of the class file further includes: setting a counter corresponding to the instruction in the class file when it is determined that the class file does not comprise the non deterministic class and/or the non deterministic function, wherein the counter is used for counting an execution frequency of the instruction during the execution of the smart contract.

In an embodiment of the present application, before deploying the class file, the method further includes: determining that a deployment request for deploying the class file is legal.

In an embodiment of the present application, the determining that a deployment request for deploying the class file is legal includes: implementing a consensus process on the format of the deployment request, and determining the invoking request is legal when all nodes reach a consensus that the format of the deployment request is legal.

According to another aspect of the present application, an embodiment of the present application provides a device for processing smart contracts, including: a determining module, configured to determine a class file corresponding to a smart contract to be invoked based on an invoking request of the smart contract; and an execution module, configured to execute the smart contract to be invoked based on the class file; wherein the class file is pre-compiled based on a program logic of the smart contract.

In an embodiment of the present application, the class file includes an instruction and a counter corresponding to the instruction; wherein the execution module is further configured to count an execution frequency of the instruction by using the counter, and stop executing the instruction when the execution frequency is more than a preset frequency.

In an embodiment of the present application, the class file includes a plurality of instructions, and corresponding weight is set for each of the instructions; wherein the preset frequency of the instruction is fewer as the weight of the instruction is greater.

In an embodiment of the present application, the determining module is further configured to search the class file corresponding to the smart contract in a class file library based on the invoking request.

In an embodiment of the present application, the determining module is further configured to obtain identification information, used for indicating the smart contract, in the invoking request; and searching the class file corresponding to the smart contract in the class file library according to the identification information obtained.

In an embodiment of the present application, the device for processing smart contracts further includes: a generation module, configured to generate the class file which satisfies the invoking request according to the identification information, used for indicating the smart contract, in the invoking request.

In an embodiment of the present application, the execution module is further configured to instantiate the class file and determining functions and parameters in the invoking request; and executing the smart contract invoked by the invoking request based on the class file instantiated, the functions and the parameters.

In an embodiment of the present application, the device for processing smart contracts further includes: a first confirmation module, configured to determine the invoking request of the smart contract to be invoked is legal before determining a class file corresponding to the smart contract based on the invoking request of the smart contract.

In an embodiment of the present application, the first confirmation module is further configured to implement a consensus process on a format of the invoking request, and determining the invoking request is legal when all nodes reach a consensus that the format of the invoking request is legal.

In an embodiment of the present application, the device for processing smart contracts further includes: a deployment module, configured to load the class file to be deployed through a class file loader; and deploy the class file to form a class file library when it is determined that the class file does not comprise a non deterministic classes and/or a non deterministic functions.

In an embodiment of the present application, the deployment module is further configured to set a counter corresponding to the instruction in the class file when it is determined that the class file does not comprise the non deterministic class and/or the non deterministic function, wherein the counter is used for counting an execution frequency of the instruction during the execution of the smart contract.

In an embodiment of the present application, the deployment module is further configured to deploy the class file at a local node or in a storage device that communicates with the local node to form the class file library.

In an embodiment of the present application, the device for processing smart contracts further includes: a second confirmation module, configured to determine a deployment request of the class file is legal before the deployment module deploys the class file.

In an embodiment of the present application, the second confirmation module is further configured to implement a consensus process on a format of the deployment request, determining the invoking request is legal when all nodes reach a consensus that the format of the deployment request is legal.

According to another aspect of the present application, an embodiment of the present application provides a method for deploying smart contracts, including: acquiring a deployment request, wherein the deployment request comprises a class file pre-compiled based on a program logic of the smart contract to be deployed; and deploying the class file when it is determined that the class file does not comprise a non deterministic class and/or a non deterministic function.

In an embodiment of the present application, the deployment process of the class file further includes: setting a counter corresponding to an instruction in the class file when it is determined that the class file does not comprise the non deterministic class and/or the non deterministic function, wherein the counter is used for counting an execution frequency of the instruction during the execution of the smart contract.

In an embodiment of the present application, the class file is deployed at a local node or in a storage device that communicates with the local node to form a class file library.

In an embodiment of the present application, before deploying the class file, the method further includes: determining the deployment request of the class file is legal.

In an embodiment of the present application, the determining the deployment request of the class file is legal includes: implementing a consensus process on a format of the deployment request, determining an invoking request is legal when all nodes reach a consensus that the format of the deployment request is legal.

According to another aspect of the present application, an embodiment of the present application provides a device for deploying smart contracts, including: an acquiring module, configured to acquire a deployment request, wherein the deployment request comprises a class file pre-compiled based on a program logic of the smart contract to be deployed; and a deployment execution module, configured to deploy the class file when it is determined that the class file does not comprise a non deterministic class and/or a non deterministic function.

In an embodiment of the present application, the deployment execution module is further configured to set a counter corresponding to an instruction in the class file when it is determined that the class file does not comprise the non deterministic class and/or the non deterministic function, wherein the counter is used for counting an execution frequency of the instruction during the execution of the smart contract.

In an embodiment of the present application, the deployment execution module is further configured to deploy the class file at a local node or in a storage device that communicates with the local node to form a class file library.

In an embodiment of the present application, the device further includes a third confirmation module, configured to determine the deployment request of the class file is legal before deploying the class file.

In an embodiment of the present application, the third confirmation module is further configured to deploy the class file includes: implementing a consensus process on a format of the deployment request, determining a invoking request is legal when all nodes reach a consensus that the format of the deployment request is legal.

According to another aspect of the present application, an embodiment of the present application provides a computer device, comprises a memory, a processor, and a computer program stored in the memory and performed by the processor, wherein the processor executes the computer program to implement steps of any method for processing smart contracts mentioned above or any method for deploying smart contracts mentioned above.

According to another aspect of the present application, an embodiment of the present application provides a computer readable storage medium where a computer program is stored on, wherein the computer program is executed by a processor to implement steps of any method for processing smart contracts mentioned above, or any method for deploying smart contracts mentioned above.

By implementing the technical scheme of the present application, smart contracts can be directly developed based on a Java language, characteristics of deterministic calculation and finite calculation can be achieved, and no additional compiler or interpreter are required. In addition, all functions of the Java language are basically retained, the technical scheme of the present application is easy to be accessed and used, and suitable for popularization.

### BRIEF DESCRIPTION OF DRAWINGS

Embodiments are illustrated with reference to the attached figures. These attached figures are used for illustrating the basic principles. Thereby only the aspects necessary for understanding the basic principles are shown. These attached figures are not proportionate. In the attached figures, the same reference numerals represent similar features.

FIG. 1 is a flowchart of a method for processing smart contracts according to an embodiment of the present application.

FIG. 2 is a flowchart of executing the smart contract to be invoked in a method for processing smart contracts according to an embodiment of the present application.

FIG. 3 is a flowchart of a method for processing smart contracts according to another embodiment of the present application.

FIG. 4 is a flowchart of a method for processing smart contracts according to another embodiment of the present application.

FIG. 5 is a flowchart of a method for processing smart contracts according to another embodiment of the present application.

FIG. 6 is a flowchart of a method for invoking the smart contract according to an embodiment of the present application.

FIG. 7 is a structural diagram of a device for processing smart contracts according to an embodiment of the present application.

FIG. 8 is a structural diagram of a device for processing smart contracts according to another embodiment of the present application.

FIG. 9 is a structural diagram of a device for processing smart contracts according to another embodiment of the present application.

FIG. 10 is a structural diagram of a device for processing smart contracts according to another embodiment of the present application.

FIG. 11 is a structural diagram of a device for processing smart contracts according to an embodiment of the present application.

FIG. 12 is a flowchart of a method for deploying smart contracts according to an embodiment of the present application.

FIG. 13 is a flowchart of a method for deploying smart contracts according to another embodiment of the present application.

FIG. 14 is a flowchart of a method for deploying smart contracts according to another embodiment of the present application.

FIG. 15a is a flowchart of a method for deploying smart contracts according to an embodiment of the present application.

FIG. 15b is a structural diagram of a device for class files according to an embodiment of the present application.

FIG. 16 is a structural diagram of a device for deploying smart contracts according to an embodiment of the present application.

FIG. 17 is a structural diagram of a device for deploying smart contracts according to another embodiment of the present application.

FIG. 18 is a schematic diagram of a device for processing smart contracts or a device for deploying smart contracts according to another embodiment of the present invention.

### DETAILED DESCRIPTION

In specific descriptions of following preferred embodiments, attached figures forming a part of the present application may be referred to. The attached figures illustrate, by way of example, specific embodiments capable of realizing the present application. Embodiments of examples are not intended to exhaust all the embodiments according to the present application. It can be understood that, within the scope of the present application, structural or logical modulation may be made in the embodiments, or other embodiments may be applied. Thereby the following specific description is not restrictive and the scope of the present application is limited by the appended claims.

Technologies, methods and equipment known by those skilled in the art may not be discussed in detail. Where appropriate, the technologies, methods and equipment shall be considered as parts of the specification. The connection wires between units in the attached figures are just used for facilitating the illustration and indicating that at least the units at the two ends of each connection wire communicates with each other, however those present connection wires are not intend to limit that those unites unwired to each other cannot perform intercommunication.

First, terms and related technologies involved in the application are interpreted in advance. Java is a high-level programming language, and class files are compiled products of Java source codes and used for loading concrete procedure logics. The environment in which Java programs run is called Java Virtual Machine (JVM). Java Virtual Machine provides class loading mechanism. Through the mechanism, the class files may be managed while Java programs are running. A functional module that implements the mechanism is called a class loader. A deterministic function is a function that always returns the same value every time when a specific set of input values is invoked. Correspondingly, if a function returns different results, the function is a non-deterministic function.

Smart contracts are commitments defined in a digital form, based on which contractual participants can perform agreements of the commitments. The smart contract itself and the process of the contract execution can be observed, and the process and the judgment of contract execution can be verified. The smart contract itself and the information related to the contract can only be contacted by a relevant contract party. Only when a conflict occurs, the relevant information will be exposed to a third party to review.

Blockchain technology is based on decentralized peer-to-peer network, which combines the cryptography principle with the consensus mechanism to ensure data consistency and persistence of distributed nodes, and to achieve instant verification, traceability, tamper-resistance and shield-resistance of information. Thereby a value shared system, which is private, efficient and secure, is created by the blockchain technology. Smart contracts refer to the decentralized application technology used to achieve complex functions and provided by the blockchain technology. The smart contract is written in high-level languages, compiled by corresponding compilers to generate codes that can be recognized and executed by the blockchain, and then deployed in the blockchain to provide corresponding functions.

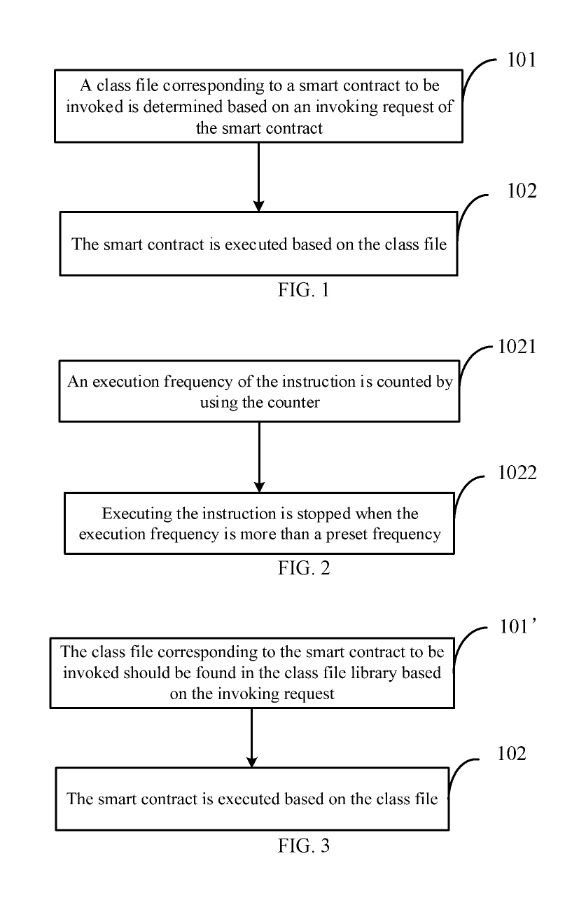

FIG. 1 is a flowchart of a method for processing smart contracts according to an embodiment of the present application. As shown in FIG. 1, the method includes the following steps.

Step 101, a class file corresponding to a smart contract to be invoked is determined based on an invoking request of the smart contract. The class file is pre-compiled based on a program logic of the smart contract.

Step 102, the smart contract is executed based on the class file. Specific executing processes may include firstly instantiating the class file and determining the functions and parameters in the invoking request for calling the smart contract, and then executing the smart contract based on the class file instantiated, the functions and the parameters.

Thus it can be seen that the embodiment of the present application actually provides a smart contract execution system (execution engine) based on the Java virtual machine and a flow and an algorithm corresponding to the system. By using the blockchain platform of the execution system, development of the smart contract by using Java language can be supported. Further, all languages that run on the Java virtual machine (also known as the JVM language), which include Scala, Groovy, Jython and so on, can be used to develop the smart contract. Since the program logic of the smart contract has been compiled into the class file based on a Java language, the smart contract can be developed based on a Java language, and additional development of compilers and interpreters are not required. Developers can directly develop and apply the blockchain technology by using Java language functions. Thus it can be seen that the technical scheme of the present application is easy to be accessed and meets engineering level application requirements, and is also easy for commercial application and suitable for market promotion.

It should be understood that because the class file is compiled according to the smart contract, the content of the class file actually includes the program logic content of the smart contract. Thus in the description of some subsequent embodiments, there is no strict logical distinction between the concept of the class file and the concept of the smart contract. For example, it is actually the class file being invocated, executed and deployed, when implementing invocation, execution and deployment of the smart contract.

In an embodiment, because inventors have found that, when the smart contract is realized by combining the blockchain technology, the smart contract needs to satisfy the following requirements. The calculating process should be limited, and there should be no dead loops and infinite recursion. Therefore, the class file may include an instruction and a counter corresponding to the instruction. As shown in FIG. 2, the execution of the smart contract to be invoked may include the following steps.

Step 1021, an execution frequency of the instruction is counted by using the counter.

Step 1022, executing the instruction is stopped when the execution frequency is more than a preset frequency.

For example, it is supposed that the class file corresponding to the smart contract to be invoked includes instruction 1 and instruction 2, the execution frequency of the instruction 1 is one, and the execution frequency of the instruction 2 is three. Assuming the instruction 2 is the instruction to be invoked, the counter of the instruction 2 increases the count once each time when the instruction 2 is executed. Thus, if the preset frequency of the instruction 2 is set to be four, the class file can be fully executed. Conversely, if the preset frequency of the instruction 2 is set to be two, the class file will not be able to be executed completely or a result of an error prompt is output.

In an embodiment, corresponding weight may be set for each of the instructions. In this case, the preset frequency of the instruction is fewer when the weight of the instruction is greater. By adjusting the weight of the corresponding instruction, the execution frequency of instruction can be limited accordingly. For example, by increasing the weight of the instruction 2, the allowed execution frequency of the instruction 2 will be further reduced. Similarly, by reducing the weight of the instruction 2, the allowed execution frequency of the instruction 2 will be increased.

Therefore, by counting the execution frequency of the instructions, a large number of repetitive invocations to a specific instruction, which are intentionally issued by a user/node or caused by a system failure, can be avoided, and the blockchain's characteristic of finite calculating is guaranteed. For example, in a bidding system, by adding a counter after an instruction corresponding to the withdrawal of the bidding operation, an user can be prevented from maliciously withdrawing the bidding repeatedly, and paralysis or failure of the whole bidding system due to the operation of a specific user can be avoided. Understandably, the counter may be set at different locations according to specific applications.

In an embodiment of the present application, inventors find that, when the smart contract is realized by combining the blockchain technology, the smart contract also needs to satisfy the following requirements. On different nodes or at different times, a same output can always be obtained when a same input is entered, which is called deterministic calculating. Therefore, when the class file is pre-deployed, the class file including a non deterministic class and/or a non deterministic function can be excluded to ensure that executable class files can be deterministically calculated. Specifically, the deploying process of the class file may include following steps. The class file to be deployed is loaded by, for example, a class loader to determine whether the class file uses a non deterministic function. If there is one class generating a call to the non deterministic function in the class file, the deployment of the smart contract is stopped and it is prompted that the deployment is failed. When it is determined that the class file never ever use a non deterministic function, the smart contract is deployed. It can be understood by those skilled in the art that there may be different prompting ways in different applications. For example, the result of the deployment failure is returned to the user to inform (e.g., through an interface visible to the user) that the smart contract submitted by the user cannot be deployed in the blockchain.

In an embodiment of the present application, considering that both the deterministic calculating requirement and the finite calculating requirement of the smart contract should be satisfied, when deploying a class file, a counter corresponding to an instruction is set in the class file when it is determined that the class file does not include the non deterministic class and/or the non deterministic function. Specifically, the class file of the smart contract may be processed through a class loader and a byte-code enhancer. The class loader is used for determining whether a loaded class file contains the non deterministic function, and refusing to load the class containing the non deterministic function based on this ability. The byte-code enhancer is used for analyzing and modifying the class file and counting the execution frequency of each invoked instruction in the class file during the execution of the class file. The compiled smart contract is diffused in the multi-node system (e.g., the blockchain) through P2P or other transmission modes, and each node receives the class file of the smart contract. Nodes in the blockchain (e.g., validation nodes) implement a consensus process (a process to reach a consensus on an object) on the received class file according to a specified rule, or save the received smart contract in a memory first, and trigger the consensus process and the processing of the smart contract when a new round of consensus arrives. Understandably, the consensus process in the present application may be implemented on one or more class files.

In an embodiment of the present application, in order to improve the operation reliability of the class file's deployment, it is necessary to determine whether the deployment request is legal before deploying the class file. Specifically, the node received the deployment request may verify the legality of the deployment request to determine whether the deployment request is legal. The legality verification is a kind of formal verification of the deployment request. That is to say, the node will verify the format or other parameters of the deployment request, and then determine whether the deployment request is legal. For example, it is determined that whether the format of the deployment request is applicable to the current blockchain. Understandably, legality verifications with other judging rules may be applied in other embodiments.

In a further embodiment, for the blockchain, the above legality verification may be implemented through a consensus mechanism. Specifically, a consensus process may be implemented on the format of the deployment request, and when all nodes reach a consensus that the format of the deployment request is legal, the invoking request is determined as legal. Through POW, POS, PBFT or other consensus algorithms, multiple nodes received the deployment request verify the legality of the deployment request, and then it is determined whether the deployment request is legal for the current blockchain. Based on the result of the consensus process, different operations may be executed. Specifically, if the result of the consensus process indicates that the deployment request is not legal (for example, the format of the deployment request does not satisfy the requirements), the deployment of the smart contract will be ended. If the result of the consensus process indicates that the deployment request is legal (for example but not limited to, the format of the deployment request satisfies the format requirements of the blockchain), the subsequent deployment operations of the class file will be performed.

In an embodiment of the present application, as shown in FIG. 3, when class files are pre-deployed to a class file library (for example, the class file is pre-deployed to a local node or to a storage device that communicates with the local node), the class file corresponding to the smart contract to be invoked should be found in the class file library based on the invoking request in advance (Step 101′), and then the smart contract is executed base on the class file found.

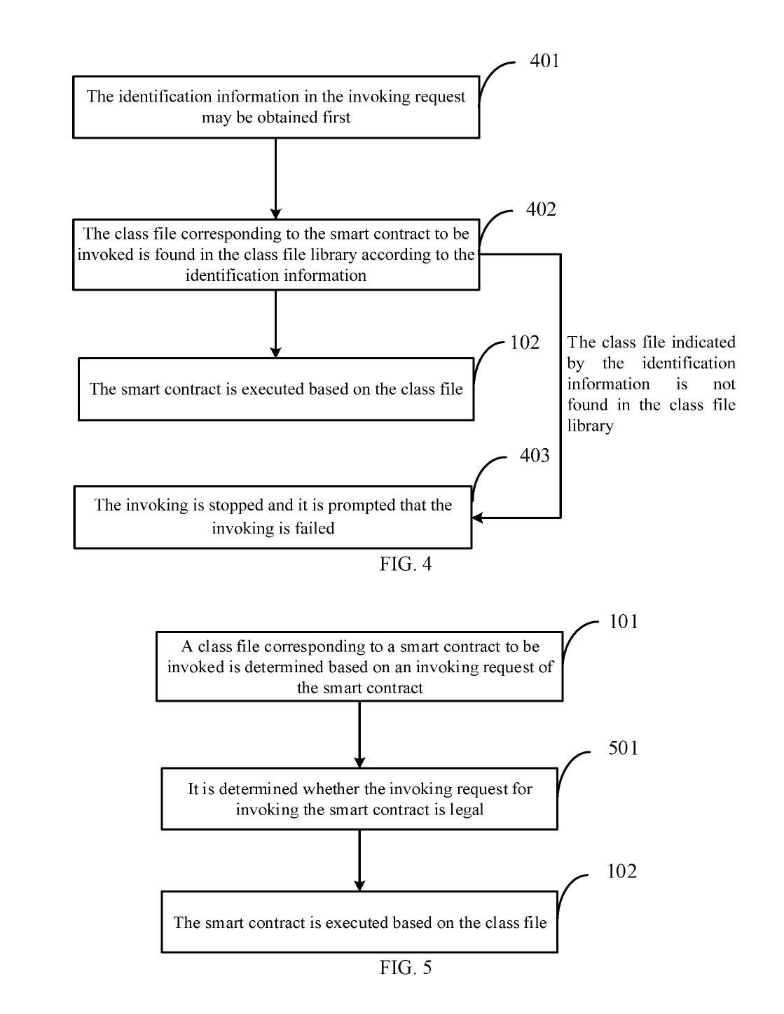

In a further embodiment, as shown in FIG. 4, when the invoking request for invoking the smart contract includes identification information used for indicating the smart contract to be invoked, the identification information in the invoking request may be obtained first (Step 401), and then the class file corresponding to the smart contract to be invoked is found in the class file library according to the identification information (Step 402). If the class file indicated by the identification information is not found in the class file library, the invoking is stopped and it is prompted that the invoking is failed (Step 403). When the class file indicated by the identification information is found in the class file library, the smart contract is executed subsequently.

In an embodiment of the present application, the class file corresponding to the smart contract to be invoked may be deployed after the invoking request is received. Specifically, the invoking request for invoking the smart contract may contain some program logic content, thus the class file have to be generated based on the identification information in the invoking request to meet the invoking request's requirements.

In an embodiment of the present application, as shown in FIG. 5, in order to improve the reliability of the operation for invoking the smart contract, it is determined whether the invoking request for invoking the smart contract is legal before executing the smart contract based on the class file (Step 501). Specifically, the node received the invoking request will determine whether the invoking request is legal. The node will verify the format or other parameters of the invoking request to determine whether the invoking request is legal. For example, the validation method determines whether the request format is applicable to the current blockchain.

In a further embodiment, the above-mentioned legality validation of the invoking request for the smart contract may also be implemented through the consensus mechanism. A consensus process may be implemented on the format of the invoking request, and when all nodes reach a consensus that the format of the invoking request is legal. For example, through POW, POS, PBFT or other consensus algorithms, multiple nodes received the invoking request verify the legality of the invoking request, and then it is determined whether the invoking request is legal for the current blockchain. Based on the result of the consensus process, the corresponding operation will be generated. Specifically, if the invoking request is not legal, the invocation of the smart contract will be ended. For example, the failure result of the invocation is returned to the user through an interface visible, informing that the smart contract to be invoked is absence or unable to be invoked. If the invoking request is determined as legal (e.g., but not limited to, the format of the invoking request satisfies the requirement of the blockchain), then the subsequent execution of the smart contract is performed.

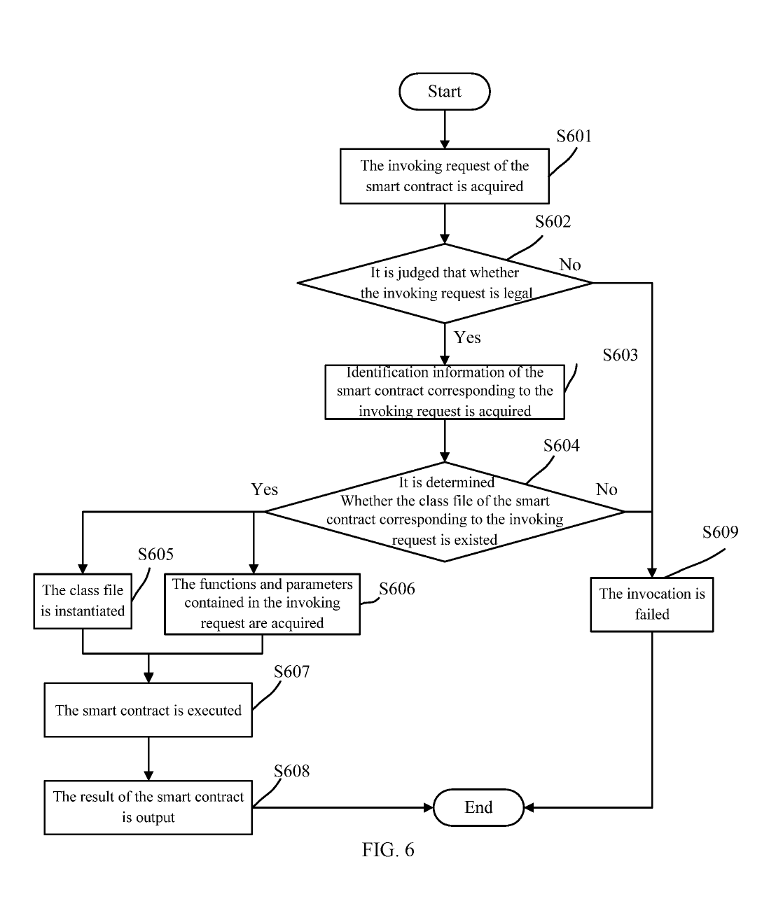

FIG. 6 is a flowchart of a method for invoking the smart contract according to an embodiment of the present application. As shown in FIG. 5, the method includes the following steps.

Step S601, the invoking request of the smart contract is acquired.

In this step, multiple nodes in the blockchain receive the invoking request of the smart contract. In this embodiment, the invoking request has a specific format. Understandably, the invoking request may be received by a node and sent to other nodes in the blockchain in a way of P2P.

Step S602, it is judged that whether the invoking request is legal.

In this step, the node received the invoking request will verify the legality of the invoking request. In this embodiment, the above node will verify the format or other parameters of the invoking request, and then determine whether the invoking request is legal. For example, it is determined whether the request format is applicable to the current blockchain.

Step S602 may be executed through a consensus mechanism. For example, through POW, POS, PBFT or other consensus algorithms, the multiple nodes received the invoking request verify the legality of the invoking request, and then it is determined whether the invoking request is legal for the current blockchain.

Based on the judgment result of Step S602, corresponding operations are executed. Specifically, if the invoking request is determined as not legal, the invocation of the smart contract is terminated and the operation of Step S609 is executed to indicate that the invocation of the smart contract is failed. For example, the failure result of the invocation is returned to the user through an interface visible, informing that the smart contract to be invoked is absence or unable to be invoked. If the invoking request is determined as legal (e.g., but not limited to, the format of the invoking request satisfies the requirement of the blockchain), Step S603 is executed.

Step S603, identification information of the smart contract corresponding to the invoking request is acquired.

In this embodiment, the invoking request has a specific format, and includes the identification information of the smart contract to be invoked and corresponding functions and parameters. In this step, the legal invoking request is analyzed to acquire the identification information contained in the legal invoking request used for indicating the smart contract. Understandably, in this step, the functions and parameters contained in the invoking request can also be acquired.

Step S604, it is determined whether the class file of the smart contract corresponding to the invoking request is existed.

In this step, based on the identification information in the invoking request, the class file is searched in a class file library (i.e., a collection of deployed smart contracts), and a corresponding operation is determined according to the searching result. If the class file which the identification information indicates is not found in the class file library, the invocation is stopped and the invocation is determined as failed (Step S609). If the class file indicated by the identification information can be found in the class file library, subsequent operations are executed.

Understandably, in an embodiment, the corresponding class file may also be generated according to the invoking request. For example, after obtaining the identification information contained in the invoking request, the class file that satisfies the invoking request may be generated by, for example, the deploying method shown in FIG. 1 or a part of the deploying method.

Step S605, the class file is instantiated.

In this step, the smart contract is instantiated based on the class file found in step S605.

Step S606, the functions and parameters contained in the invoking request are acquired.

In this step, the functions and parameters in the invoking request are acquired by analyzing the invoking request. Understandably, the functions and parameters in the invoking request may be acquired based on the results of Step S603.

Step S607, the smart contract is executed.

In this step, the smart contract is invoked according to the operation results of Step S605 and Step S606. Specifically, the smart contract corresponding to the legal invoking request is executed based on the instantiated class file and the functions and parameters in the legal invoking request, and the result of the smart contract is output (Step S608).

Although the above steps are numbered sequentially, it is understandable to those skilled in the art that the order of some of the above steps can also be adjusted. For example, the smart contract may be instantiated first (Step S605), and then functions and parameters are acquired in the invoking request (Step S606). Also Step S606 may be executed first, and then Step S605 is executed.

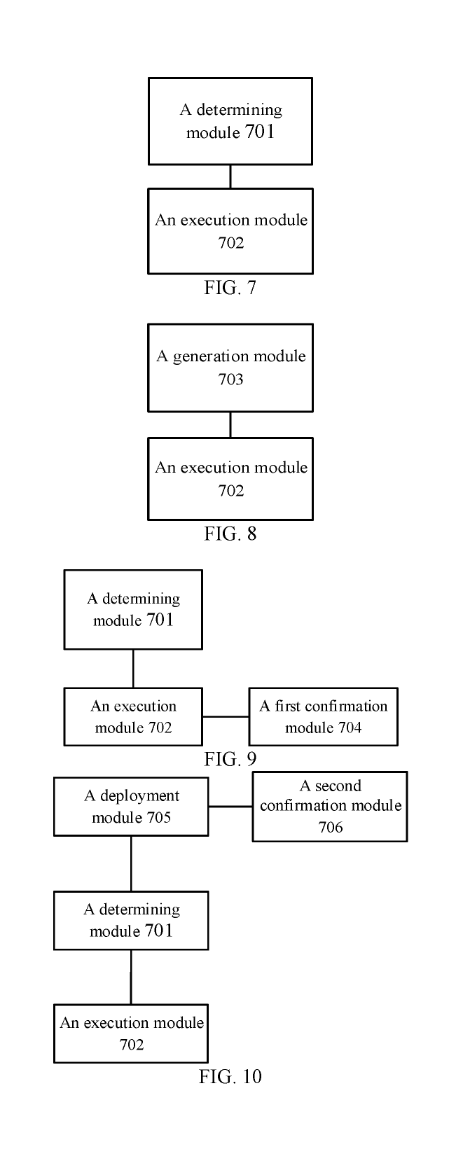

FIG. 7 is a structural diagram of a device for processing smart contracts according to an embodiment of the present application. As shown in FIG. 7, the device includes a determining module 701, configured to determine a class file corresponding to a smart contract to be invoked based on an invoking request of the smart contract; and an execution module 702, configured to execute the smart contract to be invoked based on the class file, and the class file is pre-compiled based on a program logic of the smart contract.

In an embodiment of the present application, the class file includes an instruction and a counter corresponding to the instruction. The execution module 702 is further configured to count an execution frequency of the instruction by using the counter, and stop executing the instruction when the execution frequency is more than a preset frequency.

In an embodiment of the present application, the class file includes a plurality of instructions, and corresponding weight is set for each of the instructions. The preset frequency of the instruction is fewer when the weight of the instruction is greater.

In an embodiment of the present application, the determining module 701 is further configured to search the class file corresponding to the smart contract in the class file library based on the invoking request.

In an embodiment of the present application, the determining module 701 is further configured to obtain identification information used for indicating the smart contract in the invoking request; and search the class file corresponding to the smart contract in the class file library according to the identification information obtained.

In an embodiment of the present application, as shown in FIG. 8, the device for processing smart contracts further includes a generation module 703, configured to generate the class file which satisfies the invoking request according to the identification information, used for indicating the smart contract, in the invoking request.

In an embodiment of the present application, the execution module 702 is further configured to instantiate the class file and acquire functions and parameters contained in the invoking request; and execute the invoking request for the smart contract based on the instantiated class file, the functions and the parameters.

In an embodiment of the present application, as shown in FIG. 9, the device for processing smart contracts further includes a first confirmation module 704, configured to determine the invoking request for the smart contract is legal before determining the class file corresponding to the smart contract to be invoked based on the invoking request of the smart contract.

In an embodiment of the present application, the first confirmation module 704 is further configured to implement a consensus process on the format of the invoking request, and determine the invoking request is legal when all nodes reach a consensus that the format of the invoking request is legal.

In an embodiment of the present application, as shown in FIG. 10, the device for processing smart contracts further includes a deployment module 705, configured to load the class file to be deployed through a class file loader; and deploy the class file to form a class file library when it is determined that the class file does not include a non deterministic class and/or a non deterministic function.

In an embodiment of the present application, the deployment module 705 is further configured to set counters corresponding to instructions in the class file when it is determined that the class file does not include a non-deterministic class and/or a non-deterministic function. The counters are used for counting an execution frequency of the instructions during the execution of the smart contract.

In an embodiment of the present application, the deployment module 705 is further configured to deploy the class file at a local node or in a storage device that communicates with the local node to form the class file library.

In an embodiment of the present application, as shown in FIG. 10, the device for processing smart contracts further includes a second confirmation module 706, configured to determine a deployment request of the class file is legal before the deployment module deploying the class file.

In an embodiment of the present application, the second confirmation module 706 is further configured to implement a consensus process on the format of the deployment request, and determine the invoking request is legal when all nodes reach a consensus that the format of the deployment request is legal.

It should be understood that each module recorded in the device for processing smart contracts provided by the above-mentioned embodiments corresponds to one of the steps in the aforementioned method for processing smart contracts. Thus, operations and characteristics described in the steps of the method described above are also applicable to the device and the corresponding modules contained therein, and the repetitive contents will not be repeated here.

FIG. 11 is a structural diagram of a device for processing smart contracts according to an embodiment of the present application. As shown in FIG. 11, the processing device 300 includes an invoking request receiving unit 301, an invoking request analysis unit 302, a class file selection unit 303 and an execution unit 304. Specifically, the invoking request receiving unit 301 is configured to receive the invoking request for the smart contract and verify the legality of the invoking request to determine that the invoking request is legal. The invoking request analysis unit 302 communicates with the invoking request receiving unit 301, and is configured to analyze the legal invoking request to obtain identification information used for indicating the corresponding smart contract in the legal invoking request. The class file selection unit 303 is configured to compare current identification information with the identification information of each class file in the class file library, and then select the class file corresponding to the legal invoking request. The execution unit 304 is configured to execute the corresponding smart contract based on the class file and the invoking request determined by the class file selection unit 303. Specifically, the execution unit 304 instantiates the class file and implements the smart contract corresponding to the legal invoking request by combining the function and the parameter in the invoking request.

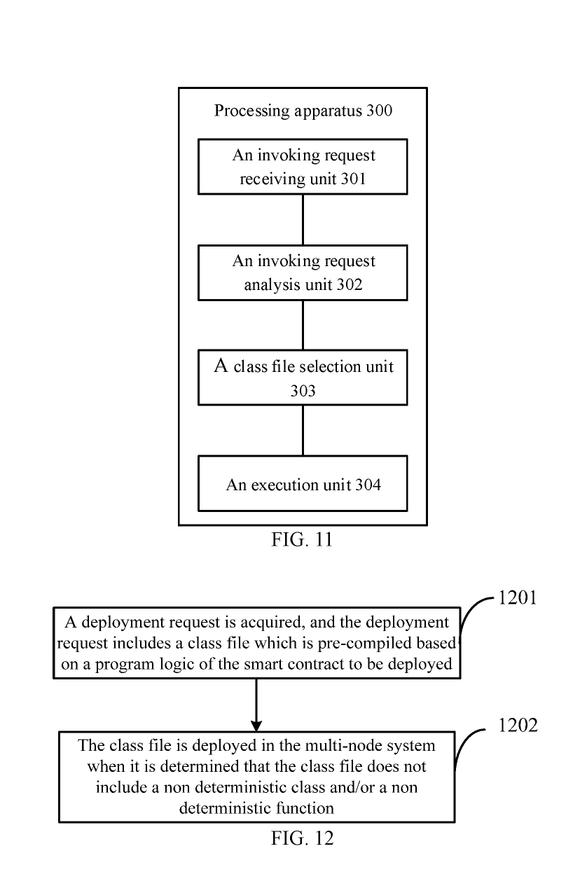

FIG. 12 is a flowchart of a method for deploying smart contracts according to an embodiment of the present application. As shown in FIG. 12, the method includes the following steps.

Step 1201, a deployment request is acquired, and the deployment request includes a class file which is pre-compiled based on a program logic of the smart contract to be deployed.

Step 1202, the class file is deployed when it is determined that the class file does not include a non deterministic class and/or a non deterministic function. For example, the class file is deployed at a local node or in a storage device that communicates with the local node to form a class file library.

If there is one class generating a call to the non deterministic function in the class file, the deployment of the smart contract is stopped and it is prompted that the deployment is failed, When it is determined that the class file never ever use a non deterministic, the class file is deployed. It can be understood by those skilled in the art that there may be different prompting ways in different applications. For example, the result of the deployment failure is returned to the user to inform (e.g., through an interface visible to the user) that the smart contract submitted by the user cannot be deployed in the blockchain.

Thus, when the class file is pre-deployed, the class file including a non-deterministic class and/or a non-deterministic function can be excluded to ensure that executable class files can be deterministically calculated, and the corresponding smart contract satisfies the following requirements when the smart contract is realized by combining the blockchain technology. On different nodes, or at different times, a same output can always be obtained when a same input is entered.

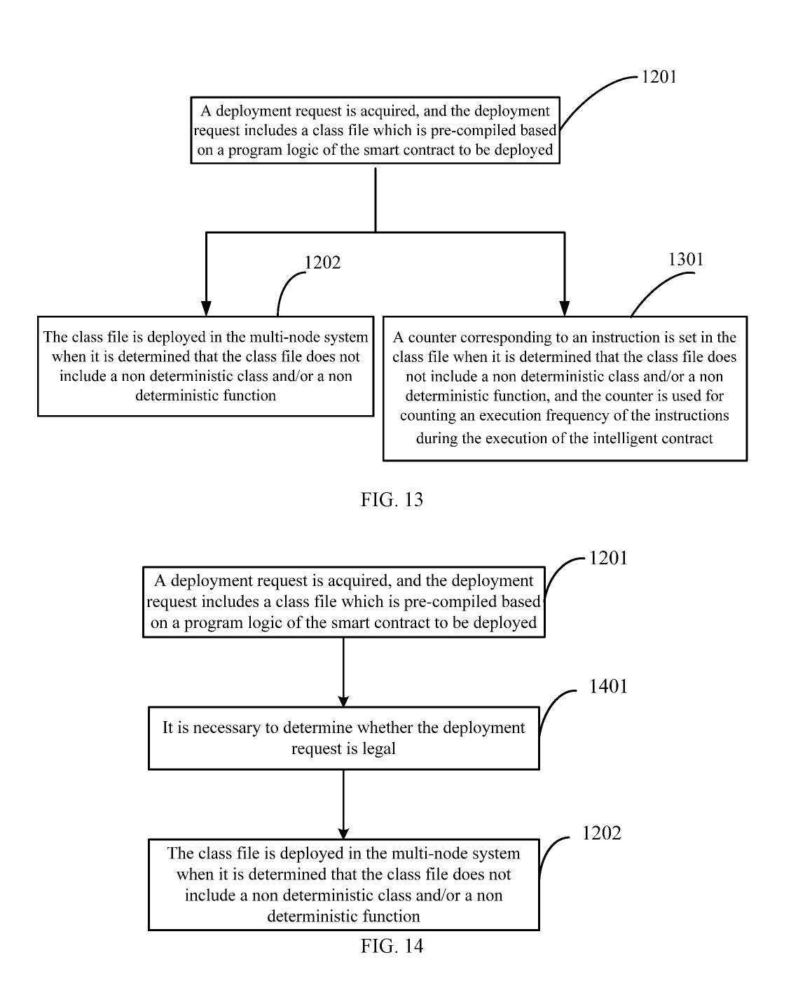

In an embodiment of the present application, as shown in FIG. 13, considering both the deterministic calculating requirement and the finite calculating requirement of the smart contract should be satisfied, the method for deploying the smart contract may further include the followings. A counter corresponding to an instruction is set in the class file when it is determined that the class file does not include a non deterministic class and/or a non deterministic function, and the counter is used for counting an execution frequency of the instructions during the execution of the smart contract (Step 1301). Specifically, the class file of the smart contract may be processed through a class loader and a byte-code enhancer. The class loader is used for determining whether a loaded class file contains the non deterministic function and refusing to load the class containing the non deterministic function based on this ability. The byte-code enhancer is used for analyzing and modifying the class file and counting the execution frequency of each invoked instruction in the class file during the execution of the class file. The compiled smart contract is diffused in the multi-node system (e.g., the blockchain) through P2P or other transmission modes, and each node receives the class file of the smart contract. Nodes in the blockchain (e.g., validation nodes) implement a consensus process (a process to reach a consensus on an object) on the received class file according to a specified rule, or save the received smart contract in a memory first, and trigger consensus process and processing of the smart contract when a new round of consensus arrives. Understandably, the consensus process in the present application may be implemented on one or more class files.

In an embodiment of the present application, as shown in FIG. 14, in order to improve the operation reliability of the class file's deployment, it is necessary to determine whether the deployment request is legal before deploying the class file (Step 1401). Specifically, the node received the deployment request may verify the legality of the deployment request to determine whether the deployment request is legal. The legality verification is a kind of formal verification of the deployment request. That is to say, the above node will verify the format or other parameters of the deployment request, and then determine whether the deployment request is legal. For example, it is determined whether the format of the deployment request is applicable to the current blockchain. Understandably, the legality verification with other judging rules may also be applied in other embodiments.

In a further embodiment, for the blockchain, the above legality verification may be performed through a consensus mechanism. Specifically, a consensus may be implemented on the format of the deployment request and when all nodes reach a consensus that the format of the deployment request is legal, the invoking request is determined as legal. Through POW, POS, PBFT or other consensus algorithms, multiple nodes received the deployment request verify the legality of the deployment request, and then it is determined whether the deployment request is legal for the current blockchain. Based on the result of the consensus process, different operations may be executed. Specifically, if the result of the consensus process indicates that the deployment request is not legal (for example, the format of the deployment request does not satisfy the requirements), the deployment of the smart contract will be ended. If the result of the consensus process indicates that the deployment request is legal (for example but not limited to, the format of the deployment request satisfies the format requirements of the blockchain), the subsequent deployment operations of the class file will be performed.

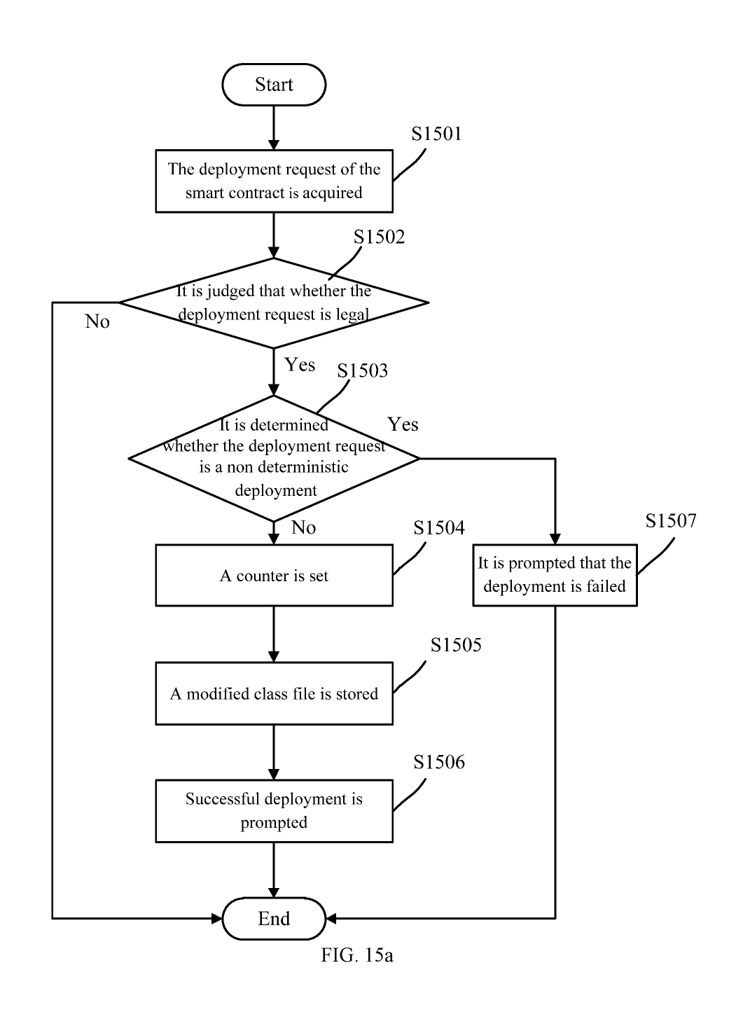

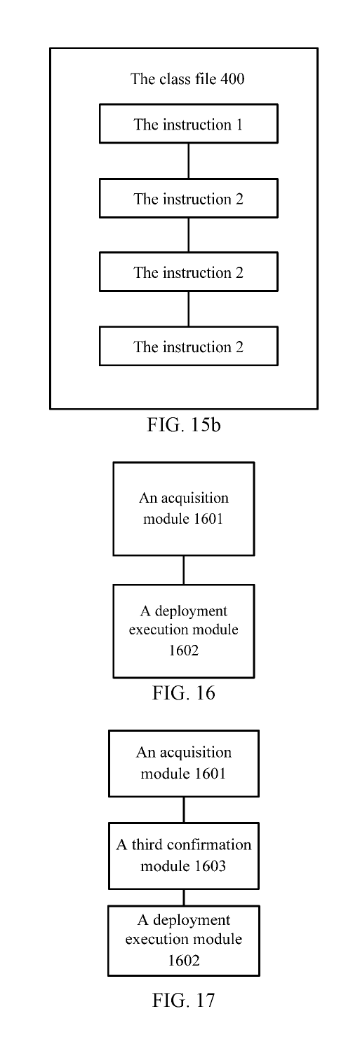

FIG. 15a is a flowchart of a method for deploying smart contracts according to an embodiment of the present application. As shown in FIG. 15a, the deployment method of the smart contract includes the following steps.

Step S1501, The deployment request of the smart contract is acquired.

In this step, multiple nodes in the blockchain will receive the deployment request of the smart contract. In this embodiment, the deployment request has a specific format and includes a class file of the smart contract (i.e., the class file to be deployed). Understandably, the deployment request may be received by a node and then sent to other nodes in the blockchain in a way of P2P.

Step S1502, it is judged that whether the deployment request is legal.

In this step, the node received the deployment request will verify the legality of the deployment request to determine the deployment request is legal. In this embodiment, the legality verification is a formal test of the deployment request, that is to say, the above node will verify the format or other parameters of the deployment request, and then determine whether the deployment request is legal. For example, it is determined whether the format of the deployment request is applicable to the current blockchain. Understandably, the legality verification with other judgment rules also may be applied.

For the blockchain, Step S1502 may be executed through a consensus mechanism. Specifically, through POW, POS, PBFT or other consensus algorithms, the multiple nodes received the deployment request verify the legality of the deployment request, and then it is determined whether the deployment request is legal for the current blockchain.

Based on the consensus result of Step S1502, different operations will be executed. Specifically, if the consensus result indicates that the deployment request is not legal (for example, the format of the deployment request does not satisfy the requirements), the deployment of the smart contract will be terminated. If the consensus result indicates that the deployment request is legal (for example but not limited to, the format of the deployment request satisfies the format requirements of the blockchain), Step S1503 is executed.

Step S1503, it is determined whether the deployment request is a non deterministic deployment.

As mentioned above, the deployment request has the specific format and includes the class file to be deployed. Thus, the class file to be deployed is loaded by, for example, a class loader to determine whether the class file uses a non deterministic function. If there is one class generating a call to the non deterministic function in the class file, the deployment of the smart contract is stopped and it is prompted that the deployment is failed (Step S1507). If the class loader determines that the class file of the smart contract never ever use a non deterministic function (that is, the class file does not include the non deterministic class), Step S1504 is executed. It can be understood by those skilled in the art that there may be different prompting ways in different applications. For example, the result of the deployment failure is returned to the user to inform (e.g., through an interface visible to the user) that the smart contract submitted by the user cannot be deployed in the blockchain.

Step S1504, a counter is set.

In this step, the counter is set for a specified instruction, so that an execution frequency of an invoked instruction can be counted. Following is a description of the execution of the class file after setting the counter with FIG. 15b.

As shown in FIG. 15b, the execution frequency of the instruction 1 executed by the class file 400 is one, and the execution frequency of the instruction 2 is three. As mentioned above, assuming the instruction 2 is the specified instruction, the counter increases once every time when the instruction 2 is executed. Thus, if a threshold value of the execution frequency of the instruction 2 is set to be greater than or equal to four, the class file 400 can be fully executed; conversely, if the threshold value of execution frequency of the instruction 2 is set to be two, the class file 400 will not be able to be executed completely or a result of an error prompt is output.

In one implementation, corresponding weight may be set for each of the instructions. Still taking the instruction shown in FIG. 14b as an example, by adjusting the weight of the corresponding instruction, the execution frequency of the instruction can be limited accordingly. For example, by increasing the weight of the instruction 2, the allowed execution frequency of the instruction 2 will be further reduced. Similarly, by reducing the weight of the instruction 2, the allowed execution frequency of the instruction 2 will be increased.

Therefore, by counting the execution frequency of the instructions, a large number of repetitive invocations to a specific instruction, which are intentionally issued by a user/node or caused by a system failure, can be avoided, and the blockchain's characteristic of finite calculating is guaranteed. For example, in a bidding system, by adding the counter after the instruction corresponding to the withdrawal of bidding operations, the user can be prevented from maliciously withdrawing the bidding operations repeatedly, and paralysis or failure of the whole bidding system due to the operation of a specific user can be avoided. Understandably, the counter may be set at different locations according to specific applications.

Step S1505, a modified class file is stored.

As can be seen from the previous step, an unmodified class file to be deployed does not contain the counter. In this embodiment, the class file is modified by the byte-code enhancement technology and the counter is set for the specified instruction. The modified class file to be deployed will be stored in a specified location (e.g., at a node in the blockchain or in a storage device connected to the node) to achieve the deployment of a class file to a class file library and complete the construction of the class file library.

When the above storage step is completed, Step S1506 will be executed: successful deployment is prompted. For example, a result of the successful deployment is returned to the user to inform through an interface visible to the user that the smart contract submitted by the user is deployed in the blockchain.

Through the above steps, the deployment of the class file of the smart contract is realized, and the class file in the blockchain is deterministic and finite, as a result, the stability of the network is improved. Specifically, the class files to be deployed are selected based on whether the class files including the non-deterministic class and/or the non-deterministic function, thus the class files selected and retained are deterministic. In addition, since the counter is set for the specified instruction of the modified class file, when the threshold value is set for the execution frequency of the instruction, the execution frequency of the instruction can be limited by comparing the output value of the counter with the threshold value, and the class file invoked has characteristics of finite calculation.

FIG. 16 is a structural diagram of a device for deploying smart contracts according to an embodiment of the present application. As shown in FIG. 16, the device includes followings.

An acquiring module 1601 is configured to acquire a deployment request. The deployment request includes a class file, which is pre-compiled based on a program logic of the smart contract to be deployed. And a deployment execution module 1602 is configured to deploy the class file when it is determined that the class file does not include a non-deterministic class and/or a non-deterministic function.

In an embodiment of the present application, the deployment execution module 1602 is further configured to set a counter corresponding to instructions in the class file when it is determined that the class file does not include the non-deterministic class and/or the non-deterministic function. And the counter is used for counting an execution frequency of the instruction during the execution of the smart contract.

In an embodiment of the present application, the deployment execution module 1602 is further configured to deploy the class file at a local node or in a storage device connected to the local node to form a class file library.

In an embodiment of the present application, as shown in FIG. 17, the device for deploying the smart contract further includes a third verification module 1603, which is configured to determine that the deployment request of the class file is legal before deploying the class file.

In an embodiment of the present application, the third verification module 1603 is further configured to implement a consensus process on the format of the deployment request, and determine the invoking request is legal when all nodes reach a consensus that the format of the deployment request is legal.

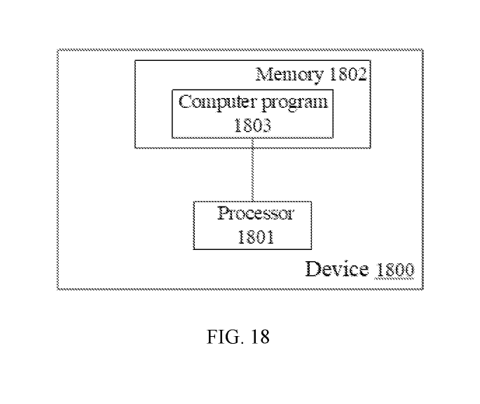

FIG. 18 is a schematic diagram of a device for processing smart contracts or a device for deploying smart contracts according to another embodiment of the present invention. As shown in FIG. 18, the device 1800 includes a memory 1802, a processor 1801, and a computer program 1803 stored on the memory 1802 and executed by the processor 1801; when the computer program 1803 is executed by the processor 1801, the processor 1801 implements anyone of the methods for processing smart contracts or anyone of the methods for deploying smart contracts according to embodiments described above.

It should be understood that each module recorded in the device for deploying the smart contract provided by the above-mentioned embodiments corresponds to one of the steps in the aforementioned method for deploying the smart contract. Thus, operations and characteristics described in the steps of the method described above are also applicable to the device and the corresponding modules contained therein, and the repetitive contents will not be repeated here.

It should be understood, the process of the any one of previous methods may also be implemented as machine readable instructions that include programs performed by a processor. The programs may be materialized in software stored on a tangible computer readable medium such as CD-ROM, floppy disk, hard disk, digital versatile disk (DVD), Blu-ray disk or other forms of memory. Alternatively, some or all of the steps in the previous methods may be implemented by any combination of application specific integrated circuits (ASIC), programmable logic devices (PLD), field programmable logic devices (FPLD), discrete logic, hardware, firmware, etc. In addition, although the data processing method is described in a flowchart corresponding to any one of the foregoing methods, the steps in the previous methods may be modified, deleted, or merged.

As mentioned above, the process of any one of the previous methods may also be implemented by encoding instructions (such as computer readable instructions) which are stored on a tangible computer readable medium such as hard disk, flash memory, read-only memory (ROM), compact disk (CD), digital video disk (DVD), high-speed cache, random access memory (RAM), and/or any other storage mediums. The information on the storage medium may be stored for any periods (for example, for a long time, permanently, briefly, temporarily buffered, and/or cached information). As is used herein, the term tangible computer readable medium is expressly defined to include any type of computer readable stored signal. Additionally or alternatively, the example procedure of any one of the previous methods may be implemented by the encoding instructions (such as computer readable instructions) which is stored non-temporary computer readable media such as hard disk, flash memory, read-only memory, compact disk, digital video disk, high-speed cache, RAM, and/or any other storage medium. The information on the storage medium may be stored for any periods (for example, for a long time, permanently, briefly, temporarily buffered, and/or cached information).

The present application supports the development of the smart contract based on a Java language, and characteristics of deterministic calculation and finite calculation can be achieved, and no additional compiler or interpreter are required. In addition, all functions of Java language are basically retained, the technical scheme of the present application is easy to be accessed and used.

Therefore, although the present application is described with specific examples which are merely intended to be illustrative rather than to limit the application, it is obvious to those skilled in the art that the disclosed embodiments may be changed, added or deleted without departing from the spirit and scope of protection of the application.

What is claimed is:

1. A method for processing smart contracts, comprising:
determining a class file corresponding to a smart contract to be invoked based on an invoking request of the smart contract; and
executing the smart contract based on the class file;
wherein the class file is pre-compiled based on a program logic of the smart contract.

2. The method of claim 1, wherein the class file comprises an instruction and a counter corresponding to the instruction;
wherein the executing the smart contract based on the class file comprises:
counting an execution frequency of the instruction by using the counter, and stop executing the instruction when the execution frequency is more than a preset frequency.

3. The method of claim 1, wherein the class file comprises a plurality of instructions, and corresponding weight is set for each instruction;
wherein the preset frequency of the instruction is fewer when the weight of the instruction is greater.

4. The method of claim 1, wherein the determining a class file corresponding to a smart contract to be invoked based on an invoking request of the smart contract comprises:
searching the class file corresponding to the smart contract in a class file library based on the invoking request.

5. The method of claim 4, wherein the searching the class file corresponding to the smart contract in a class file library based on the invoking request comprises:
obtaining identification information, used for indicating the smart contract, in the invoking request; and
searching the class file corresponding to the smart contract in the class file library according to the identification information obtained.

6. The method of claim 1, wherein the determining a class file corresponding to a smart contract to be invoked based on an invoking request of the smart contract comprises:
generating the class file which satisfies the invoking request according to the identification information, used for indicating the smart contract, in the invoking request.

7. The method of claim 1, wherein the executing the smart contract based on the class file comprises:
instantiating the class file and determining functions and parameters in the invoking request; and
executing the smart contract based on the class file instantiated, the functions and parameters.

8. The method of claim 1, wherein before the determining a class file corresponding to a smart contract to be invoked based on an invoking request of the smart contract, the method further comprises:
determining the invoking request is legal.

9. The method of claim 8, wherein the determining the invoking request is legal comprises:
implementing a consensus process on a format of the invoking request, and determining the invoking request is legal when all nodes reach a consensus that the format of the invoking request is legal.

10. The method of claim 1, wherein the class file is pre-deployed, and a deployment process of the class file comprises:
loading the class file to be deployed through a class file loader; and
deploying the class file to form a class file library when it is determined that the class file does not comprise a non deterministic class and/or a non deterministic function.

11. The method of claim 10, wherein the deployment process of the class file further comprises:
setting a counter corresponding to the instruction in the class file when it is determined that the class file does not comprise the non deterministic class and/or the non deterministic function, wherein the counter is used for counting an execution frequency of the instruction during the execution of the smart contract.

12. The method of claim 10, wherein before deploying the class file, the method further comprises:
determining that a deployment request for deploying the class file is legal.

13. The method of claim 12, wherein the determining that a deployment request for deploying the class file is legal comprises: implementing a consensus process on the format of the deployment request, and determining the invoking request is legal when all nodes reach a consensus that the format of the deployment request is legal.

14. A device for processing smart contracts, comprising: a memory, a processor, and a computer program stored on the memory and executed by the processor, wherein when the computer program is executed by the processor, the processor implements the following steps:
determining a class file corresponding to a smart contract to be invoked based on an invoking request of the smart contract; and
executing the smart contract based on the class file;
wherein the class file is pre-compiled based on a program logic of the smart contract.

15. The device of claim 14, wherein the class file comprises an instruction and a counter corresponding to the instruction;
wherein when implementing the step of executing the smart contract based on the class file, the processor specifically implements the following step:
counting an execution frequency of the instruction by using the counter, and stop executing the instruction when the execution frequency is more than a preset frequency.

16. The device of claim 15, wherein the class file comprises a plurality of instructions and corresponding weight is set for each instruction;
wherein the preset frequency of the instruction is fewer as the weight of the instruction is greater.

17. The device of claim 14, wherein when implementing the step of determining a class file corresponding to a smart contract to be invoked based on an invoking request of the smart contract, the processor specifically implements the following step:
searching the class file corresponding to the smart contract in a class file library based on the invoking request.

18. The device of claim 17, wherein when implementing the step of searching the class file corresponding to the smart contract in a class file library based on the invoking request, the processor specifically implements the following steps:
obtaining identification information, used for indicating the smart contract, in the invoking request; and
searching the class file corresponding to the smart contract in the class file library according to the identification information obtained.

19. The device of claim 14, wherein when implementing the step of determining a class file corresponding to a smart contract to be invoked based on an invoking request of the smart contract, the processor specifically implements the following step:
generating the class file which satisfies the invoking request according to the identification information, used for indicating the smart contract, in the invoking request.

20. The device of claim 14, wherein when implementing the step of executing the smart contract based on the class file, the processor specifically implements the following step:
instantiating the class file and determining functions and parameters in the invoking request;
and executing the smart contract invoked by the invoking request based on the class file instantiated, the functions and parameters.

21. The device of claim 14, wherein when the computer program is executed by the processor, the processor further implements the following step:
determining the invoking request of the smart contract to be invoked is legal before determining a class file corresponding to the smart contract based on the invoking request of the smart contract.

22. The device of claim 21, wherein when implementing the step of determining the invoking request of the smart contract to be invoked is legal, the processor specifically implements the following step:
implementing a consensus process on a format of the invoking request, and determining the invoking request is legal when all nodes reach a consensus that the format of the invoking request is legal.

23. The device of claim 14, wherein when the computer program is executed by the processor, the processor further implements the following steps:
loading the class file to be deployed through a class file loader; and
deploying the class file to form a class file library when it is determined that the class file does not comprise a non deterministic classes and/or a non deterministic functions.

24. The device of claim 23, wherein when the computer program is executed by the processor, the processor further implements the following steps: setting a counter corresponding to the instruction in the class file when it is determined that the class file does not comprise the non deterministic class and/or the non deterministic function, wherein the counter is used for counting an execution frequency of the instruction during the execution of the smart contract.

25. The device of claim 23, wherein when implementing the step of deploying the class file to form a class file library when it is determined that the class file does not comprise a non deterministic classes and/or a non deterministic functions, the processor specifically implements the following step: deploying the class file at a local node or in a storage device that communicates with the local node to form the class file library.

26. The device of claim 23, wherein when the computer program is executed by the processor, the processor further implements the following step:
determining that a deployment request of the class file is legal before the deployment module deploys the class file.

27. The device of claim 26, wherein when implementing the step of determining a deployment request of the class file is legal before the deployment module deploys the class file, the processor specifically implements the following steps:
implementing a consensus process on a format of the deployment request; and
determining the invoking request is legal when all nodes reach a consensus that the format of the deployment request is legal.

28. A computer readable storage medium where a computer program is stored on, wherein the computer program is executed by a processor to implement steps of a method for processing smart contracts, comprising:
determining a class file corresponding to a smart contract to be invoked based on an invoking request of the smart contract; and
executing the smart contract based on the class file;
wherein the class file is pre-compiled based on a program logic of the smart contract.
